(19) United States
(12) Patent Application Publication
(10) Pub. No.: US 2015/0058633 A1
(43) Pub. Date: Feb. 26, 2015

(54) SELF-AUTHENTICATED TAG GENERATION METHOD AND INTERPRETATION METHOD USED IN THE SELF-AUTHENTICATED KEY SYSTEM

(71) Applicants: Li LIU, San Francisco, CA (US); Steve Yi long CHAO, San Francisco, CA (US); Chenggong YANG, San Francisco, CA (US)

(72) Inventors: Li LIU, San Francisco, CA (US); Steve Yi long CHAO, San Francisco, CA (US); Chenggong YANG, San Francisco, CA (US)

(21) Appl. No.: 13/872,104

(22) Filed: Apr. 27, 2013

(51) Int. Cl. H04L 29/06

(52) U.S. Cl. CPC H04L 63/0823; H04L 63/045; H04L 63/0485
USPC 713/175

(57) ABSTRACT

The present invention relates to a self-authenticated tag generation method and interpretation method used in the self-authenticated key system, which comprises the following steps: inputting data by the publisher; generating tag via a self-authenticated tag device by the publisher; transmitting generated tag to the receiver; interpreting tag via the self-authenticated tag device by the receiver; and displaying data. The present invention is easy and safe, the generated self-authenticated tag can be transmitted by various carriers, can distinguish the object and upload abundant information without easily tampered. Moreover, the acquisition of the public key is not achieved by the third party, which decreases wasting the network resources, and avoids the unsecure factors brought by the third party.

### TECHNICAL FIELD

The invention relates to a self-authenticated key system, especially relates to a self-authenticated tag generation method and interpretation method used in the self-authenticated key system.

### BACKGROUND ART

During the wide spread of the Internet, when the users enjoy the diversified data, they have to face the challenges for data security as well. Actually, along with the generation of data, encryption is emerged in the right moment. The two common encryption algorithms are Symmetric Cryptography Algorithms and Asymmetric Cryptography Algorithms, wherein, the Symmetric Cryptography Algorithms uses the same key for encrypting and decrypting; and the Asymmetric Cryptography Algorithms uses different key for encrypting and decrypting.

The Asymmetric Cryptography Algorithm has been proved to be an effective method for information protection in the network environment, it authenticates and encrypts data by the public/private key pairs. Currently, PKI system is the main Asymmetric Cryptography Algorithms, wherein, the obtainment and authentication of the public key can be achieved by the third party. However, the security of the third party brings potential security risks for system, and the authentication of the third party consumes too much network resources.

Therefore, a new self-authenticated key system is needed to protect the security for the network application. During the implementation of the self-authenticated key, the key is exchanged between the two parties who communicated in the event without the need of the third party such as Certificate Authority(CA). The public key can be obtained locally in the process of authentication, encryption and decryption, thus the both parties who participate the information communication achieve the key-based authentication to the other parties, namely, the communication between the users can achieve self-certification.

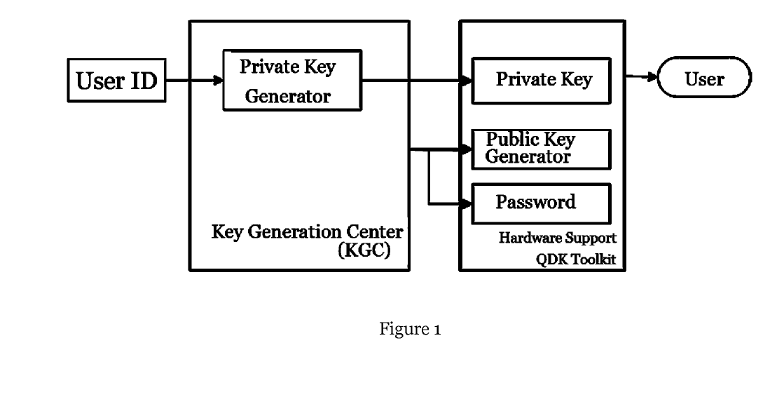

Each user end of the self-authenticated key system comprises the public key information of the all units in the system, and the publishing process of which is shown as FIG. 1.

The acquisition and update of the self-authenticated key relate to the interactions between the users and the key generation and management authority. But the authority is not involved in the process of the information authentication and encryption/decryption between the users. The required public keys are obtained locally by the users according to ID of the interaction object. The sender and receiver can input the public user ID provided by the other party into the public key generator to determine the corresponding public key by itself, thus the public key can be get locally and combined with private key to achieve the data exchange confidentially. In the process, the public key is not obtained by the third party, thus the consumption of the network resources are reduced, and the insecurity factors created by the third party are avoided.

### SUMMARY OF THE INVENTION

The present invention aims at solving the technical problems and provides a self-authenticated tag generation method and interpretation method used in the self-authenticated key system, which can identify the object and upload abundant information, and not easily be tampered.

The technical scheme of the present invention is to provide a self-authenticated tag generation method and interpretation method used in the self-authenticated key system, which comprises the following steps:

1. inputting data by the publisher;

2. generating tag via a self-authenticated tag device by the publisher;

3. transmitting generated tag to the receiver;

4. interpreting tag via the self-authenticated tag device by the receiver; and

5. displaying data.

In Step 2, generating tag via the self-authenticated tag device by the publisher comprises the following procedures:

a. encrypting the inputted data by the publisher with key pack to obtain the encrypted data. The said encrypted data comprises: the encrypted data, which is generated by symmetrically encrypting the inputted data via symmetric passwords by the publisher, and the encrypted passwords, which is generated by asymmetrically encrypting the symmetric passwords by using his own private key;

b. sending the obtained encrypted data and his own ID to the self-authenticated tag device by the publisher, and generating self-authenticated tag.

In Step 2, generating tag via the self-authenticated tag device by the publisher comprises the following procedures:

a. encrypting the inputted data by the publisher with key pack to obtain the encrypted data. The said encrypted data comprises: the encrypted data, which is generated by encrypting the inputted data via passwords by the publisher, and the encrypted passwords, which is generated by asymmetrically encrypting the symmetric passwords by using receiver's ID and sender's local public key information;

b. sending the obtained encrypted data to the self-authenticated tag device by the publisher, and generating self-authenticated tag.

In Step 4, interpreting tag by the receiver comprises the following procedures:

a. sending the obtained self-authenticated tag to the self-authenticated tag device by the receiver, and interpreting the tag to obtain the encrypted data, encrypted passwords and sender's ID;

b. the receiver with key pack decrypts the encrypted data and encrypted passwords by using the sender's ID to obtain the decrypted data.

The said decrypting step comprises: sending the publisher's public key and the sender's encrypted passwords to the cypher decryptor so as to obtain the symmetric passwords, wherein, the publisher's public key is obtained by the publisher's ID and the local public key information; sending the encrypted data and the obtained symmetric passwords to the data decyptor to obtain the final data.

In Step 4, interpreting tag by the receiver comprises the following procedures:

a. sending the obtained self-authenticated tag to the self-authenticated tag device by the receiver, and interpreting the tag to obtain the encrypted data and encrypted passwords of the sender;

b. the receiver with key pack decrypts the sender's encrypted data by using the his own private key to obtain the decrypted data.

The said decrypting step comprises: sending the his own private key and the sender's encrypted passwords to the cypher decryptor so as to obtain the symmetric passwords; and sending the encrypted data and the obtained symmetric passwords to the data decryptor to obtain the final data.

The self-authenticated tag device is the generation and interpretation device for the carrier of the self-authenticated tag, wherein, the carrier requires satisfying the following three conditions: a. identifying event attribute; b. carrying self-authenticated encrypted information as an information carrier; c. generating and reading by the client device. Therefore, the self-authenticated tag device can be an AR code generating and reading device, a two-dimensional QR code generating and reading device, NFC device, RFID device or Beidou Satellite system.

The local public key information is the set of the original public key or the public key generator in which the ID is converted to the public key, the users can input the user ID to the public key generator to obtain the user public key.

The set of the original public key is the locally packed user ID and the public key data, which is sent to the user from the key generating center, and the user can obtain the corresponding public key by user ID look-up table (LUT). The key management center provides updates for the public key, which comprises periodic update and announcement update. The periodic update is operated as follows: the management center periodically issues the patches which packed new public key and voided public key as an update pack, and the user use the update pack to update the local public key library. The announcement update is operated as follows: the system sends the update pack to the users in announcement way, keeps the user's public key library updating to achieve real-time updating the voided and new public key; the any unit of the system sends prompting message to the users, and the users can fetch the update pack from the center after receiving the prompting message.

The self-authenticated tag generation method and interpretation method used in the self-authenticated key system of the invention is safe and easy to generate the tag. The generated self-authenticated tag has the advantages of being transmitted by various carriers, and distinguishing the object and upload abundant information without easily tampered. Moreover, the acquisition of the public key is not achieved by the third party, which decreases wasting the network resources, and avoids the unsecure factors brought by the third party.

### BRIEF DESCRIPTION OF THE INVENTION

FIG. 1 shows a schematic view of a user key distribution according to the prior art;

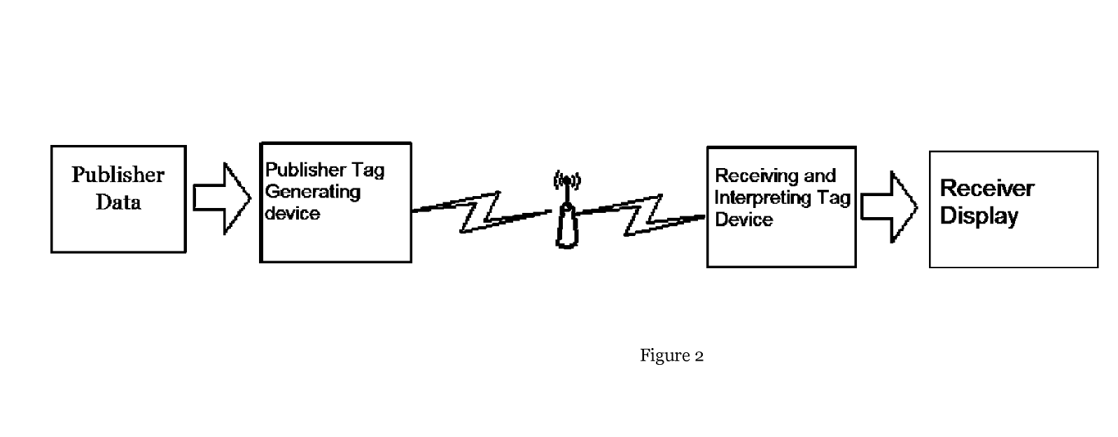

FIG. 2 shows a self-authenticated tag system according to the invention;

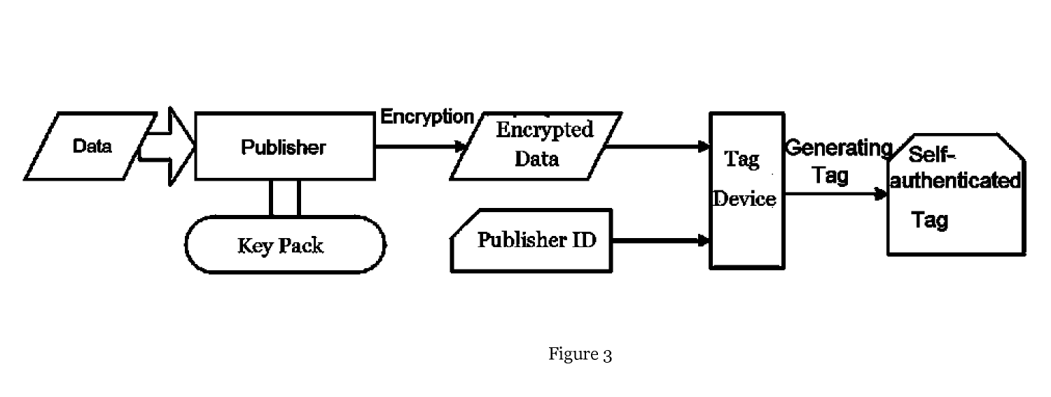

FIG. 3 shows a flow of the self-authenticated tag generation according to the invention;

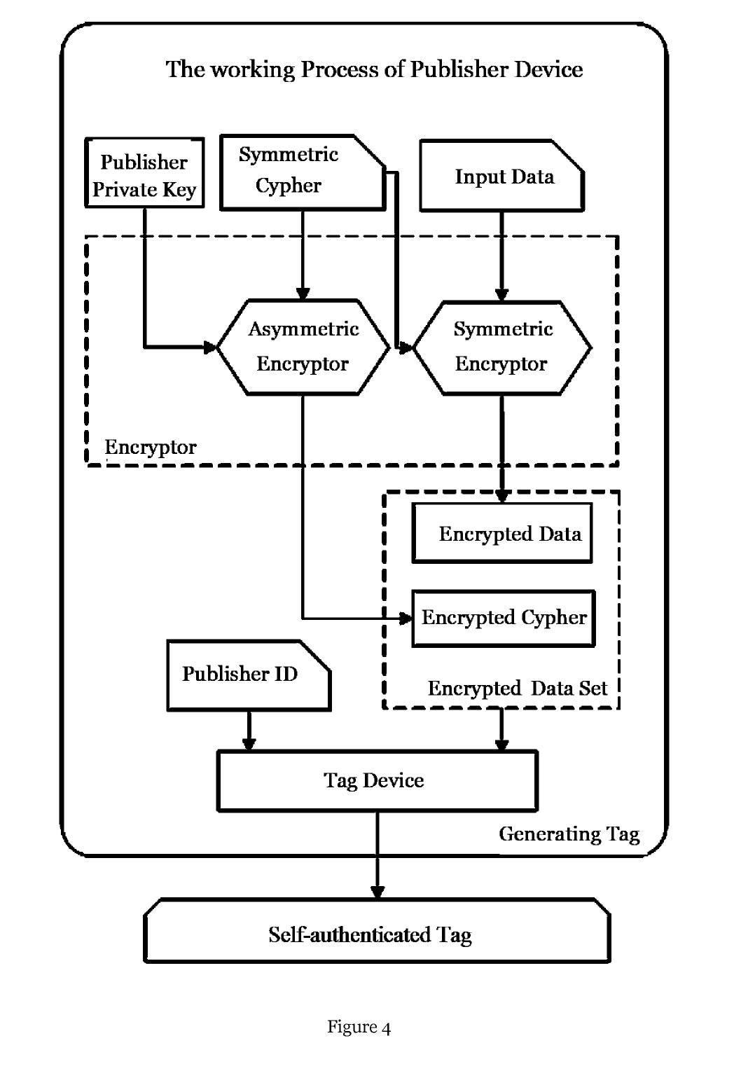

FIG. 4 shows a specific process flow of the self-authenticated tag generation according to the invention;

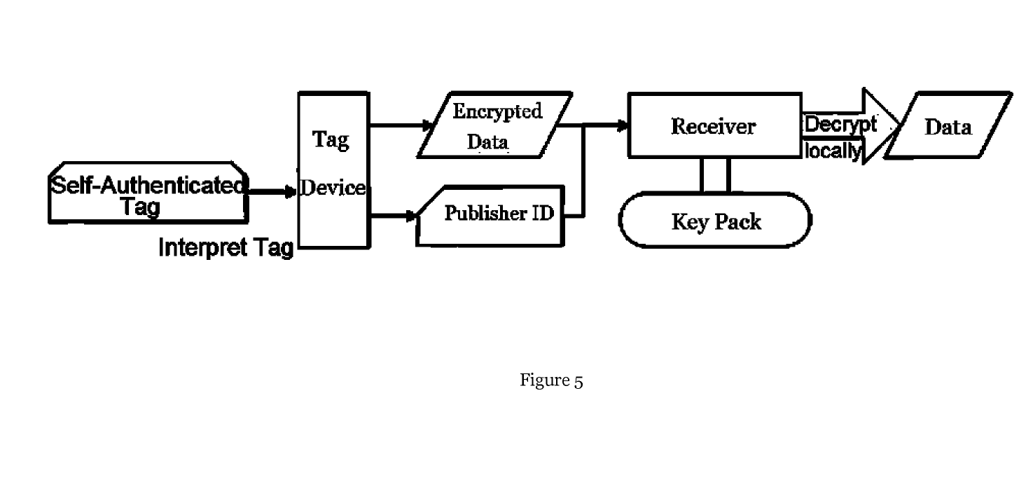

FIG. 5 shows a flow of the self-authenticated tag interpretation according to the invention; and

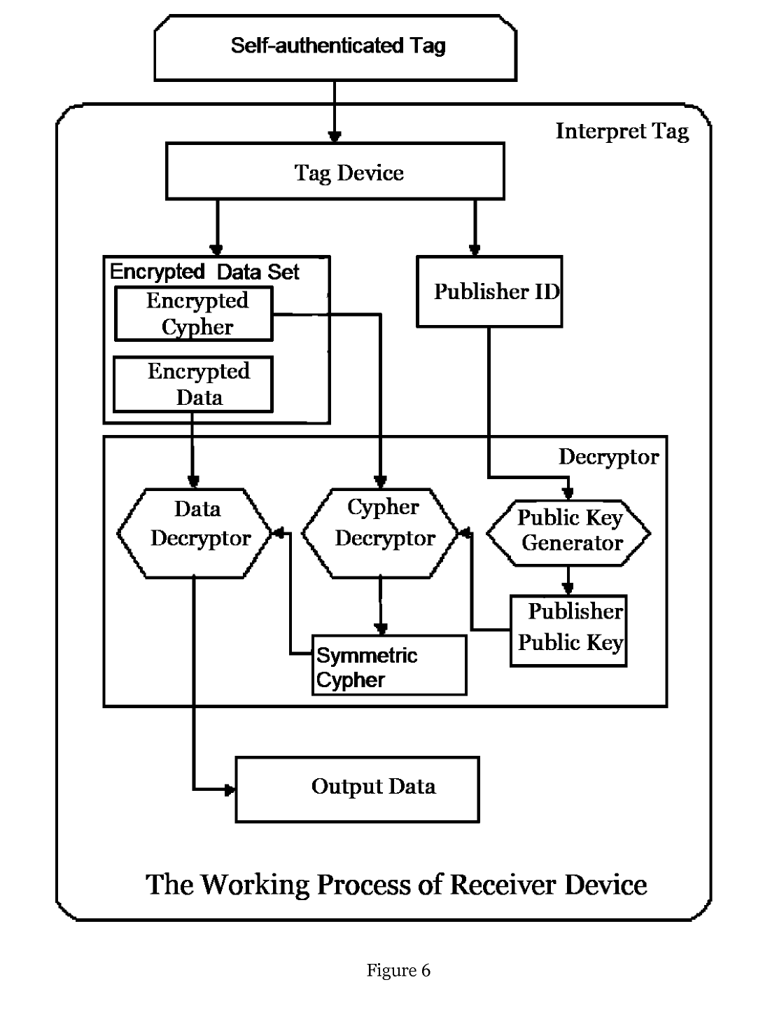

FIG. 6 shows a specific process flow of the self-authenticated tag interpretation according to the invention.

### DETAILED DESCRIPTION OF THE INVENTION

The self-authenticated tag generation and interpretation method used in the self-authenticated key system of the present invention will be described in detail by various embodiments in conjunction with the accompanying drawings.

The self-authenticated tag is an application based on the self-authenticated system. Generally, the tag is used for identifying the classification or content of the objects, distinguishing the objects from different class or attributes. Moreover, the self-authenticated tag is a special tag with encrypted information that can distinguish object and upload abundant information.

The self-authenticated tag is generated by the user's terminal which has the function of self-certification. The terminal comprises the public key generator and the function of encryption/decryption, and the tag generation and interpretation are off-line processed by the user's terminal. The publisher sends the data to be published to the publisher tag generating device so as to generate encrypted self-authenticated tag. By network communication, the user as the receiver can receive and interpret the self-authenticated tag by using the receiving and interpreting tag device, thus obtaining the useful data and displaying on the receiver side.

In the generation process of the self-authenticated tag, the user uses key pack to encrypt the data, combines the encrypted data with the user ID, and to generate the tag containing user ID and the encrypted data by using the tag generating method (such as a two-dimensional generator).

After obtaining the self-authenticated tag, the receiver interprets the tag by a tag device (such as decryption software), and obtains publisher's ID and encrypted data, thus the receiver can realize self-authenticated decryption locally and can obtain useful data.

Generally, the self-authenticated system adopts combining the asymmetric encryption method and symmetric encryption method. The symmetric encryption method is faster or more effective, while the asymmetric encryption method is slower. A possible encryption method is adopting symmetric cryptography algorithms for data encryption, and asymmetric cryptography algorithms for password encryption.

As shown in FIG. 2, the self-authenticated tag generation and interpretation method of the present invention comprises the following steps:

1. inputting data by the publisher;

2. generating tag via a self-authenticated tag device by the publisher;

As shown in FIG. 3 and FIG. 4, generating tag by the publisher comprises the following procedures:

a. encrypting the inputted data by the publisher with key pack to obtain the encrypted data;

the said encrypted data comprises: the encrypted data, which is generated by symmetrically encrypting the inputted data via symmetric cyphers by the publisher; and the encrypted passwords, which is generated by asymmetrically encrypting the symmetric passwords by using his own private key;

b. sending the obtained encrypted data and his own ID to the self-authenticated tag device by the publisher, and generating self-authenticated tag;

3. transmitting generated tag to the receiver;

4. interpreting tag via the self-authenticated tag device by the receiver;

As shown in FIG. 5 and FIG. 6, interpreting tag by the receiver comprises the following procedures:

a. sending the obtained self-authenticated tag to the self-authenticated tag device by the receiver, and interpreting the tag to obtain the encrypted data, encrypted passwords and sender's ID;

the said decrypting step comprises: sending the publisher's public key and the sender's encrypted passwords to the cypher decryptor so as to obtain the symmetric passwords, wherein, the publisher's public key is obtained by the publisher's ID and the public key generator; sending the encrypted data and the obtained symmetric passwords to the data decryptor to obtain the final data.

b. the receiver with key pack decrypts the encrypted data and encrypted passwords by using the sender's ID to obtain the decrypted data.

5. displaying data.

The implementation of the above-mentioned self-authenticated tag generation and interpretation method used in the self-authenticated key system is as follows:

The tag generator generates self-authenticated tag by using his own private key for encryption, and then sends the tag to the receiver; by using self-authenticated tag and the public key generator, the receiver obtains public key of the tag generator, and decrypts the data for authentication; when the data is successfully recovered, the authentication succeeds.

The above-mentioned encryption methods of private key encryption and public key decryption can be adopted in the applications of public services, such as advertisement anti-counterfeiting. As a media means, advertising is easy to be obtained and tampered, which infringes the right of the ad owner. Provided that the advertising is encrypted in the self-authenticated tag means of the present invention as the following steps: adopting the private key of the manufacturer, self-certifying tag, and obtaining the encrypted information in tag means; then the advertising receiver receiving the manufacturer's public key by using manufacturer's ID and the public key generator, and obtaining the decrypted information by using the self-authenticated tag device and manufacturer's public key, the encrypted advertising information cannot be tampered, thus realizing anti-counterfeiting since the self-authenticated tag itself cannot be duplicated.

Another embodiment of the present invention comprises the following steps:

1. inputting data by the publisher;

2. generating tag via a self-authenticated tag device by the publisher;

Generating tag by the publisher comprises the following procedures:

a. encrypting the inputted data by the publisher with key pack to obtain the encrypted data; the said encrypted data comprises: the encrypted data, which is generated by symmetrically encrypting the inputted data via symmetric passwords by the publisher, and the encrypted passwords, which is generated by asymmetrically encrypting the symmetric passwords by using receiver's ID and sender's local public key information;

b. sending the obtained encrypted data to the self-authenticated tag device by the publisher, and generating self-authenticated tag.

3. transmitting generated tag to the receiver;

4. interpreting tag via the self-authenticated tag device by the receiver;

Interpreting tag by the receiver comprises the following procedures:

a. sending the obtained self-authenticated tag to the self-authenticated tag device by the receiver, and interpreting the tag to obtain the encrypted data and encrypted passwords of the sender;

The said decrypting step comprises: sending the his own private key and the sender's encrypted passwords to the cypher decryptor so as to obtain the symmetric passwords; and sending the encrypted data and the obtained symmetric passwords to the data decryptor to obtain the final data.

b. the receiver with key pack decrypts the sender's encrypted data by using his own private key to obtain the decrypted data.

5. displaying data.

The implementation of the above-mentioned self-authenticated tag generation and interpretation method used in the self-authenticated key system is as follows:

The tag generator obtains the receiver's public key by using tag receiver's ID and local public key information, encrypts data and generates tag which is sent to the tag receiver; the receiver decrypts tag by using his own private key for authentication; when the data is successfully recovered, the authentication succeeds.

To prevent the tag content from being tampered by the receiver, the publisher can seal the content by using his own private key firstly, and then encrypt with receiver's public key. The two steps can be reversed.

The above-mentioned methods can be adopted to provide information for specific users, such as personal delivering express, booking movie tickets. Take booking movie tickets as an example, in the process of self-certificating the tag, the publisher obtains the public key by using the self-authenticated tag device according to the ticketing user's ID, then encrypts the his own ticket information by using user's public key, and publishes or transmits to the ticket buyer. After obtaining the exclusive ticket tag, the buyer decrypts the information by using his own private key and self-authenticated tag device.

For the above-mentioned self-authenticated tag generation and interpretation method used in the self-authenticated key system, the self-authenticated tag device is the generation device for the carrier of the self-authenticated tag. The carriers of the self-authenticated tags come into many forms; the carrier of the present invention requires satisfying the following three conditions: a. identifying event attribute; b. carrying self-authenticated encrypted information as an information carrier; c. generating and reading by the client device. The self-authenticated tag can be data carriers in any possible means, which includes but not limits to the message delivery means, such as Augmented Reality (AR) code, two-dimensional QR code, NFC, RFID or Beidou Satellite short message, etc. Generally speaking, the tag shall contain user ID in plaintext and the information corresponding to key encryption. Therefore, the self-authenticated tag device can be the generating and interpreting device which corresponds to the carrier, such as an AR code generating and reading device, a two-dimensional QR code generating and reading device, NFC device, RFID device or Beidou Satellite.

The local public key information of the present invention is the set of the original public key or the public key generator. The set of the original public key is the locally packed user ID and the public key data, which is sent to the user from the key generating center, and the user can obtain the corresponding public key by user ID look-up table(LUT). The key management center provides updates for the public key, which comprises periodic update and announcement update. The periodic update is operated as follows: the management center periodically issues the patches which packed new public key and voided public key as an update pack, and the user use the update pack to update the local public key library. The announcement update is operated as follows: the system sends the update pack to the users in announcement way, keeps the user's public key library updating to achieve real-time updating the voided and new public key; the any unit of the system sends prompting message to the users, and the users can fetch the update pack from the center after receiving the message. The public key generator is used for converting the ID to public key; the users can input the user ID to the public key generator to obtain the user public key. Wherein, the public key is sent to the public key generator rather than the users, such as the patent application No. CN201310029811.X for key generating method based on the identity.

What is claimed is:

1. A self-authenticated tag generation method and interpretation method used in the self-authenticated key system, which comprises the following steps:
1) inputting data by the publisher;
2) generating tag via a self-authenticated tag device by the publisher;
3) transmitting generated tag to the receiver;
4) interpreting tag via the self-authenticated tag device by the receiver; and
5) displaying data.

2. The self-authenticated tag generation method and interpretation method used in the self-authenticated key system according to claim 1, wherein generating tag by the publisher according to Step 2) comprises the following procedures:
a. encrypting the inputted data by the publisher with key pack to obtain the encrypted data; the said encrypted data comprises: the encrypted data, which is generated by symmetrically encrypting the inputted data via symmetric cyphers password by the publisher, and the encrypted passwords, which is generated by asymmetrically encrypting the password by using his own private key; and
b. sending the obtained encrypted data and his own ID to the self-authenticated tag device by the publisher, and generating self-authenticated tag.

3. The self-authenticated tag generation method and interpretation method used in the self-authenticated key system according to claim 1, wherein generating tag by the publisher according to Step 2) comprises the following procedures:
a. encrypting the inputted data by the publisher with key pack to obtain the encrypted data; the said encrypted data comprises: the encrypted data, which is generated by symmetrically encrypting the inputted data via symmetric password by the publisher, and the encrypted passwords, which is generated by asymmetrically encrypting the passwords by using receiver's ID and sender's local public key information; and
b. sending the obtained encrypted data to the self-authenticated tag device by the publisher, and generating self-authenticated tag.

4. The self-authenticated tag generation method and interpretation method used in the self-authenticated key system according to claim 1, wherein interpreting tag by the receiver according to Step 4) comprises the following procedures:
a. sending the obtained self-authenticated tag to the self-authenticated tag device by the receiver, and interpreting the tag to obtain the encrypted data, encrypted passwords and sender's ID; and
b. the receiver with key pack decrypts the encrypted data and encrypted passwords by using the sender's ID to obtain the decrypted data.

5. The self-authenticated tag generation method and interpretation method used in the self-authenticated key system according to claim 4, wherein the said decrypting step comprises:
sending the publisher's public key and the sender's encrypted password to cypher decryptor so as to obtain the symmetric passwords, wherein, the publisher's public key is obtained by the publisher's ID and the local public key information; sending the encrypted data and the obtained symmetric passwords to data decryptor to obtain the final data.

6. The self-authenticated tag generation method and interpretation method used in the self-authenticated key system according to claim 1, wherein interpreting tag by the receiver according to Step 4) comprises the following procedures:
a. sending the obtained self-authenticated tag to the self-authenticated tag device by the receiver, and interpreting the tag to obtain the encrypted data and encrypted passwords of the sender; and
b. the receiver with key pack decrypts the sender's encrypted data by using the his own private key to obtain the decrypted data.

7. The self-authenticated tag generation method and interpretation method used in the self-authenticated key system according to claim 6, wherein the said decrypting step comprises:
sending the his own private key and the sender's encrypted passwords to cypher decryptor so as to obtain the symmetric passwords; and sending the encrypted data and the obtained symmetric passwords to data decryptor to obtain the final data.

8. The self-authenticated tag generation method and interpretation method used in the self-authenticated key system according to any one of claim 1, claim 2, claim 3, claim 4 and claim 6, wherein, the self-authenticated tag device is the generation and interpretation device for the carrier of the self-authenticated tag, wherein, the carrier requires satisfying the following three conditions:
a. identifying event attribute;
b. carrying self-authenticated encrypted information as an information carrier;
c. generating and reading by the client device;
therefore, the self-authenticated tag device can be an AR code generating and reading device, a two-dimensional QR code generating and reading device, NFC device, RFID device or Beidou Satellite system.

9. The self-authenticated tag generation method and interpretation method used in the self-authenticated key system according to any one of claim 3 and claim 5, wherein the local public key information is the set of the original public key or the public key generator in which the ID is converted to the public key, the users can input the user ID to the public key generator to obtain the user public key.

10. The self-authenticated tag generation method and interpretation method used in the self-authenticated key system according to claim 9, wherein the set of the original public key is the locally packed user ID and the public key data, which is sent to the user from the key generating center, and the user can obtain the corresponding public key by user ID look-up table(LUT); the key management center provides updates for the public key, which comprises periodic update and announcement update; the periodic update is operated as follows: the management center periodically issues the patches which packed new public key and voided public key as an update pack, and the user use the update pack to update the local public key library; the announcement update is operated as follows: the system sends the update pack to the users in announcement way, keeps the user's public key library updating to achieve real-time updating the voided and new public key; any unit of the system sends prompting message to the users, and the users can fetch the update pack from the center after receiving the prompting message.
